(19) United States
(12) Patent Application Publication
(10) Pub. No.: US 2025/0389882 A1
(43) Pub. Date: Dec. 25, 2025

(54) REFLECTIVE POLARIZING OPTICAL ELEMENT, OPTICAL DEVICE, DISPLAY APPARATUS, AND METHOD OF MANUFACTURING REFLECTIVE POLARIZING OPTICAL ELEMENT

(71) Applicant: CANON KABUSHIKI KAISHA, Tokyo (JP)

(72) Inventors: KOUICHI YONETANI, Kanagawa (JP); KANETO TSUNEMITSU, Kanagawa (JP); KUMIKO YASHIMA, Tokyo (JP)

(21) Appl. No.: 19/240,413

(22) Filed: Jun. 17, 2025

(30) Foreign Application Priority Data
Jun. 24, 2024 (JP) 2024-101321

(51) Int. Cl. G02B 5/30

(52) U.S. Cl. CPC G02B 5/3025

(57) ABSTRACT

Provided is a reflective polarizing optical element with which occurrence of separation of a film in a peripheral portion is reduced. The reflective polarizing optical element includes: a substrate including a curved surface portion having a surface forming a curved surface, the curved surface portion having, in plan view as viewed in an optical axis direction, a first diameter and a second diameter in the plan view which is longer than the first diameter; and a reflective polarizing film having a transmission axis and a reflection axis, the reflective polarizing film being bonded to the curved surface of the curved surface portion, the reflective polarizing film being arranged so that, in the plan view, an extension direction of the reflection axis and an extension direction of the first diameter are parallel to each other.

### BACKGROUND

### Field of the Technology

The present disclosure relates to a reflective polarizing optical element, an optical device, a display apparatus, and a method of manufacturing a reflective polarizing optical element.

### Description of the Related Art

In recent years, a head mounted display has been used in various fields such as virtual reality (VR), augmented reality (AR), and mixed reality (MR). The head mounted display includes an optical system for causing an image displayed on a display to be formed at a position of an eye of a user. In the head mounted display, an optical system that is reduced in size and weight and has a high image quality is achieved by folding an optical path through use of circular polarization and a half mirror. Further, the head mounted display is required to have a nose recess for the time of being worn by the user, and is also required to secure an installing space for electronic devices such as a motor and a sensor. Accordingly, the shape of the optical element used in the head mounted display is often not an axisymmetric circular shape unlike an optical element used in a digital camera, but an elliptical shape or a non-axisymmetric shape which is obtained by cutting at least one side and has a long diameter and a short diameter.

Moreover, in order to reduce the size and the weight of the head mounted display, in some cases, an element obtained by bonding a film having a desired optical characteristic to a substrate having a curved surface is also used. Examples of such a film include a polarizing film, a reflective polarizing film (polarization beam splitter (PBS) film), and a phase difference film. As an example of such an optical element, for example, in Japanese Patent Laid-Open No. 2022-091938, an optical element having a reflective polarizing film bonded thereto is disclosed.

However, in the reflective polarizing optical element as disclosed in Japanese Patent Laid-Open No. 2022-091938, it is becoming recognized that, in a durability test under a high-temperature environment, a close-contact failure portion (so-called separation) of the film may occur in a peripheral portion of the reflective polarizing optical element. Such separation may cause peeling of the film started from this separated point.

### SUMMARY

The present disclosure has been made in view of such a circumstance, and is to provide a reflective polarizing optical element with which occurrence of separation of a film in a peripheral portion is reduced, and to provide a method of manufacturing the reflective polarizing optical element.

In order to solve the above-mentioned problem, according to an aspect of the present disclosure, there is provided a reflective polarizing optical element including: a substrate including a curved surface portion having a surface forming a curved surface, the curved surface portion having, in plan view as viewed in an optical axis direction, a first diameter and a second diameter in the plan view which is longer than the first diameter; and a reflective polarizing film having a transmission axis and a reflection axis, the reflective polarizing film being bonded to the curved surface of the curved surface portion, the reflective polarizing film being arranged so that, in the plan view, an extension direction of the reflection axis and an extension direction of the first diameter are parallel to each other.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for illustrating an example of a reflective polarizing optical element according to one embodiment of the present disclosure.

FIG. 2A is an exemplary view for illustrating a substrate shape of a reflective polarizing optical element according to another embodiment of the present disclosure.

FIG. 2B is an exemplary view for illustrating a substrate shape of a reflective polarizing optical element according to another embodiment of the present disclosure.

FIG. 2C is an exemplary view for illustrating a substrate shape of a reflective polarizing optical element according to another embodiment of the present disclosure.

FIG. 3A is an explanatory view for illustrating an example of a manufacturing device for manufacturing a reflective polarizing optical element according to one embodiment of the present disclosure.

FIG. 3B is an explanatory view for illustrating an example of a reflective polarizing film used in a method of manufacturing a reflective polarizing optical element according to one embodiment of the present disclosure.

FIG. 3C is an explanatory view for illustrating an example of the reflective polarizing film used in the method of manufacturing a reflective polarizing optical element according to the one embodiment of the present disclosure.

FIG. 3D is an explanatory view for illustrating an example of the reflective polarizing film used in the method of manufacturing a reflective polarizing optical element according to the one embodiment of the present disclosure.

FIG. 3E is an explanatory view for illustrating a step of an example of the method of manufacturing a reflective polarizing optical element according to the one embodiment of the present disclosure.

FIG. 3F is an explanatory view for illustrating a step of the example of the method of manufacturing a reflective polarizing optical element according to the one embodiment of the present disclosure.

FIG. 3G is an explanatory view for illustrating a step of the example of the method of manufacturing a reflective polarizing optical element according to the one embodiment of the present disclosure.

FIG. 3H is an explanatory view for illustrating a step of the example of the method of manufacturing a reflective polarizing optical element according to the one embodiment of the present disclosure.

FIG. 4A is an explanatory view for illustrating a step of an example of a method of manufacturing a reflective polarizing optical element according to Example 1.

FIG. 4B is an explanatory view for illustrating a step of the example of the method of manufacturing a reflective polarizing optical element according to Example 1.

FIG. 4C is an explanatory view for illustrating a step of the example of the method of manufacturing a reflective polarizing optical element according to Example 1.

FIG. 4D is an explanatory view for illustrating a step of the example of the method of manufacturing a reflective polarizing optical element according to Example 1.

FIG. 4E is an explanatory view for illustrating a step of the example of the method of manufacturing a reflective polarizing optical element according to Example 1.

FIG. 4F is an explanatory view for illustrating a step of the example of the method of manufacturing a reflective polarizing optical element according to Example 1.

FIG. 4G is an explanatory view for illustrating a step of the example of the method of manufacturing a reflective polarizing optical element according to Example 1.

FIG. 5A is an exemplary view for illustrating a substrate shape of a reflective polarizing optical element according to Example 4.

FIG. 5B is an explanatory view for illustrating an example of a method of manufacturing a reflective polarizing optical element according to Example 4.

FIG. 6A is a schematic explanatory view for illustrating a step of an example of a method of manufacturing a reflective polarizing optical element according to Example 6.

FIG. 6B is a schematic explanatory view for illustrating a step of the example of the method of manufacturing a reflective polarizing optical element according to Example 6.

FIG. 7 is a schematic view for illustrating an example of a reflective polarizing optical element according to Example 7.

FIG. 8A is an explanatory view for illustrating a step of an example of a method of manufacturing a reflective polarizing optical element according to Example 8.

FIG. 8B is an explanatory view for illustrating a step of the example of the method of manufacturing a reflective polarizing optical element according to Example 8.

FIG. 8C is an explanatory view for illustrating a step of the example of the method of manufacturing a reflective polarizing optical element according to Example 8.

FIG. 8D is an explanatory view for illustrating a step of the example of the method of manufacturing a reflective polarizing optical element according to Example 8.

FIG. 8E is an explanatory view for illustrating a step of the example of the method of manufacturing a reflective polarizing optical element according to Example 8.

FIG. 8F is an explanatory view for illustrating a step of the example of the method of manufacturing a reflective polarizing optical element according to Example 8.

FIG. 8G is an explanatory view for illustrating a step of the example of the method of manufacturing a reflective polarizing optical element according to Example 8.

FIG. 8H is an explanatory view for illustrating a step of the example of the method of manufacturing a reflective polarizing optical element according to Example 8.

FIG. 9 is a schematic view for illustrating an example of an optical device using the reflective polarizing optical element according to the present disclosure.

FIG. 10A is a schematic view for illustrating an example of a display apparatus using the reflective polarizing optical element according to the present disclosure.

FIG. 10B is a schematic front view of the display apparatus exemplified in FIG. 10A.

FIG. 10C is a schematic view for illustrating an example of an internal optical configuration of the display apparatus exemplified in FIG. 10A.

### DESCRIPTION OF THE EMBODIMENTS

Embodiments and Examples are hereinafter described in detail with reference to the drawings. In the following description, common components throughout the plurality of drawings are denoted by common reference symbols. Accordingly, common components are described with reference to the plurality of drawings mutually, and description of the components denoted by the common reference symbols is omitted as appropriate. Further, dimensions, materials, shapes, relative positions of the components, and the like illustrated in the following embodiments and Examples may be freely selected, and can be changed in accordance with various conditions or a configuration of an apparatus to which the present disclosure is applied.

### First Embodiment

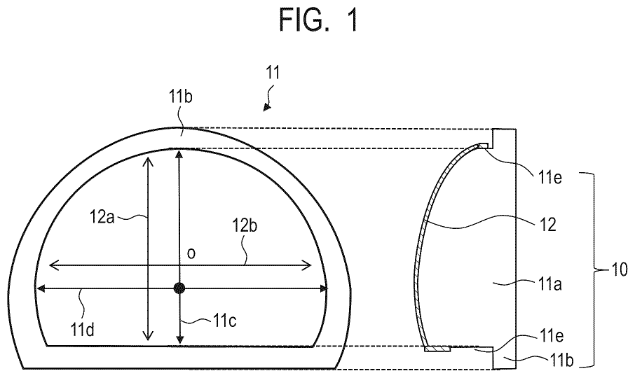

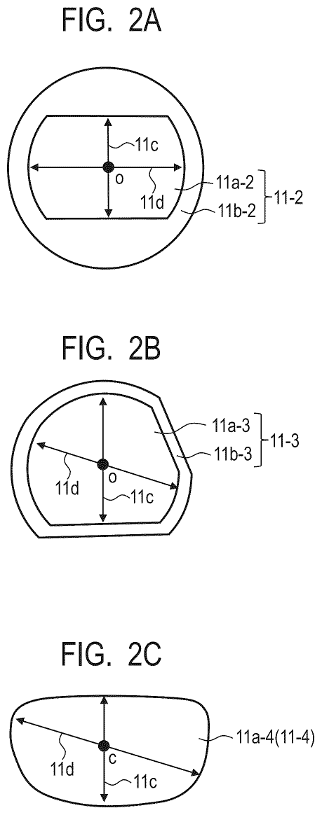

A reflective polarizing optical element according to one embodiment of the present disclosure is hereinafter described with reference to FIG. 1 to FIG. 2C. Here, the reflective polarizing film used in this embodiment includes a sheet A and a sheet B which are two layers made of different materials. In more detail, for example, those films made of different materials are alternately laminated for several hundreds of layers, and, after the lamination, the laminated film is extended in a certain direction. With the operation described above, this laminated film gains a reflective polarizing function. In such a reflective polarizing film, birefringence is caused differently in the sheet A and the sheet B due to the extension. Accordingly, the reflective polarizing film can reflect, in light that has entered the film, light that has entered the film in parallel to the extension direction (along a reflection axis) without transmitting the light, and can transmit light entering the film perpendicularly to the extension direction (along a transmission axis).

Such a reflective polarizing film has a feature in that, because the reflective polarizing film undergoes the manufacturing process described above, the reflective polarizing film is extended well in the transmission axis direction, but the reflective polarizing film is less likely to be extended in the reflection axis direction. When the reflective polarizing film is bonded to a substrate, a load in a pulling direction may be applied to the whole reflective polarizing film. According to the recognition of the feature described above, the extension of the film by the load is insufficient particularly at a peripheral portion of the reflective polarizing optical element. Thus, occurrence of separation of the film is assumed at an end portion in the reflection axis direction or the vicinity thereof because the film cannot follow a curved surface of the substrate. The present disclosure is based on the above-mentioned assumption.

FIG. 1 is a schematic view for illustrating an example of a reflective polarizing optical element 10 according to this embodiment. In FIG. 1, the view on the left side is a plan view for illustrating the reflective polarizing optical element 10 in plan view in which the reflective polarizing optical element 10 is viewed from a light incident direction, and the view on the right side is a sectional view for illustrating a cross section of the reflective polarizing optical element 10 taken along a short diameter 11c to be described later.

As illustrated in FIG. 1, the reflective polarizing optical element 10 includes a substrate 11, and a reflective polarizing film 12 bonded to the substrate 11. The substrate 11 exemplified here includes a curved surface portion 11a positioned at the center, and a peripheral edge portion 11b provided at a peripheral edge of the curved surface portion 11a so as to be adjacent to the curved surface portion 11a. In the exemplified reflective polarizing optical element 10, the reflective polarizing film 12 is provided by being bonded to a curved surface of the curved surface portion 11a.

The curved surface portion 11a has a non-axisymmetric shape in plan view as viewed in an optical axis direction of the substrate 11, and has the short diameter 11c and a long diameter 11d longer than the short diameter 11c. The optical axis direction of the substrate 11 matches an optical axis direction of the reflective polarizing optical element 10 which is a direction in which the light enters the reflective polarizing optical element 10.

In this embodiment, the short diameter 11c refers to the shortest diameter among diameters passing through a reference point of the shape of the curved surface portion 11a in plan view. The long diameter 11d refers to the longest diameter among the diameters passing through the reference point of the shape of the curved surface portion 11a in plan view. Specifically, the curved surface portion 11a has, in plan view as viewed in the optical axis direction of the substrate 11, a segmental circle shape which is a shape surrounded by an arc formed of a part of a circumference of one circle and a line connecting both ends of the arc. The line connecting both ends of the arc is, for example, a straight line, but may be a curved line, a bent line, or the like. In this case, the short diameter 11c refers to the shortest diameter among diameters passing through, as the reference point, a center point O of the circle forming the arc of the curved surface portion 11a in plan view. Further, the long diameter 11d refers to the longest diameter among the diameters passing through, as the reference point, the center point O of the circle forming the arc of the curved surface portion 11a in plan view. Thus, the short diameter 11c and the long diameter 11d are not always required to be orthogonal to each other depending on the arrangement of a part in which the arc is lacked.

The substrate 11 can function as a lens by the curved surface portion 11a. The curved surface of the curved surface portion 11a on which the reflective polarizing film 12 is to be bonded has a convex or concave shape, and may have a spherical shape or an aspherical shape. A surface of the curved surface portion 11a on a side opposite to the curved surface on which the reflective polarizing film 12 is to be bonded may be a flat surface, or may be a convex-shaped or concave-shaped curved surface. In the case of the curved surface, the curved surface may have a spherical shape or an aspherical shape.

The peripheral edge portion 11b is an optically non-effective region. For example, when the substrate 11 is manufactured, the peripheral edge portion 11b may be provided as a mold release margin used particularly when the substrate 11 is manufactured by injection molding, or may be provided in order to mount the reflective polarizing optical element 10 to a casing of an optical device of a head mounted display or the like. The peripheral edge portion 11b may have, regardless of curved surface or flat surface in particular, an axisymmetric shape or a non-axisymmetric shape. Further, the peripheral edge portion 11b is not required to be provided over the entire circumference of the curved surface portion 11a, and may be provided in a part of the entire circumference of the curved surface portion 11a. Further, the peripheral edge portion 11b is not required to be provided depending on cases. Further, the peripheral edge portion 11b can be formed of a flat surface.

Further, a step portion 11e can be provided at least at the outermost circumference of the short diameter 11c of the curved surface portion 11a. Further, when the peripheral edge portion 11b is provided, the step portion 11e is arranged between the curved surface portion 11a and the peripheral edge portion 11b to play a role of connecting the curved surface portion 11a and the peripheral edge portion 11b to each other.

The shape of the substrate 11 in plan view as viewed in the optical axis direction of the substrate 11 is not limited to the shape illustrated in FIG. 1. Examples of the shape of the substrate 11 are described below with reference to FIG. 2A to FIG. 2C. FIG. 2A to FIG. 2C are plan views for illustrating other examples of the shape of the substrate 11 in plan view as viewed in the optical axis direction of the substrate 11.

In the case of a substrate 11-2 exemplified in FIG. 2A, in plan view, a curved surface portion 11a-2 has a segmental circle shape surrounded by two arcs and two straight lines. The two arcs are left in an arrangement to be opposed to each other in a circumference of the same circle, and the two straight lines are provided as two parallel sides that are opposed to each other and connect two pairs of ends that are opposed to each other of those two arcs. In the case of the exemplified substrate 11-2, the substrate 11-2 includes a peripheral edge portion 11b-2 provided to have a circular outer shape in plan view.

In the example of the substrate 11-2, the reference point is the center point O of the circle forming the two arcs in plan view of the substrate 11-2. The short diameter 11c corresponds to a distance between two straight line parts, which passes through the center point O, and the long diameter 11d is a distance between the two arcs, which passes through the center point O and is in a direction perpendicular to the short diameter 11c.

In the case of a substrate 11-3 exemplified in FIG. 2B, in plan view, a curved surface portion 11a-3 has a segmental circle shape surrounded by two arcs and two straight lines. The two straight lines form two straight-line sides of the segmental circle shape, which extend in directions different from each other and are not opposed to each other. The two arcs are parts of a circumference of the same circle, and are arranged to connect two pairs of adjacent ends to those two sides. In the case of the exemplified substrate 11-3, the substrate 11-3 includes a peripheral edge portion 11b-3 provided to have the same width at the outer circumference of the curved surface portion 11a-3 in plan view.

In the example of FIG. 2A or FIG. 2B, a case in which the curved surface portion includes two straight lines in plan view is described. However, the number of straight lines forming the curved surface portion is not limited to two, and a plurality of three or more straight lines may be included in plan view of the substrate. In this case, the curved surface portion is only required to include, in plan view, a plurality of three or more arcs which are parts of the circumference of the same circle, and two adjacent ends of two of the plurality of straight lines are only required to be connected by each of the arcs.

Also in the example of the substrate 11-3, the reference point is the center point O of the circle forming the two arcs in plan view of the substrate 11-3. However, unlike the example of FIG. 2A, the short diameter 11c is a distance between one straight line and one arc, which is the shortest diameter among the diameters passing through the center point O. Further, the long diameter 11d is a distance between the two arcs, which is the longest diameter among the diameters passing through the center point O. In this case, the extension directions of the short diameter 11c and the long diameter 11d are not orthogonal to each other.

In the case of a substrate 11-4 exemplified in FIG. 2C, in plan view, a curved surface portion 11a-4 has a shape formed of a plurality of arcs having different curvatures like, for example, a spectacle lens. As exemplified here, a substrate 11-4 can be formed so as not to include the peripheral edge portion unlike FIG. 1 to FIG. 2B.

Further, in the exemplified substrate 11-4, there is no same circle, and hence the center point cannot be determined in plan view of the substrate 11-4. In such a case, a center-of-figure point C of the curved surface portion 11a-4 in plan view of the substrate 11-4 can be used as the reference point. With the center-of-figure point C of the shape of the curved surface portion 11a-4 in plan view being used as the reference point, the short diameter 11c becomes the shortest diameter among diameters passing through the center-of-figure point C, and the long diameter 11d becomes the longest diameter among the diameters passing through the center-of-figure point C.

An optical device, in particular, a head mounted display in which the reflective polarizing optical element 10 is used is assumed to be worn on a face, in particular, on a part of eyes and a nose of the user, and hence there are restrictions in size of the device. Accordingly, for the purpose of providing a nose recess for the user and securing an installing space for electronic devices such as a motor and a sensor, the shape of the substrate is often not an axisymmetric shape, but a non-axisymmetric shape. In such a case, the substrate shape exemplified in FIG. 2C is assumed. For such a substrate and a curved surface portion, the short diameter and the long diameter can be defined through use of the center-of-figure point C as the reference point as described above.

Any material regardless of plastic or glass can be used as the material for the substrate described above as long as the material is a transparent material that has transparency to light such as visible light being a target of the reflective polarizing optical element 10. When plastic is used, a material that can be formed by injection molding and that is optically used is preferably used. Specifically, the plastic material to be used for the substrate is preferably a material having a small birefringence. Examples thereof include polycarbonate (PC), polyester (PEs), polymethyl methacrylate (PMMA), a cycloolefin polymer (COP), and a cycloolefin copolymer (COC). In addition, when glass is used, a material thereof is not particularly limited, and examples thereof include synthetic quartz and BK-7 serving as a general glass material.

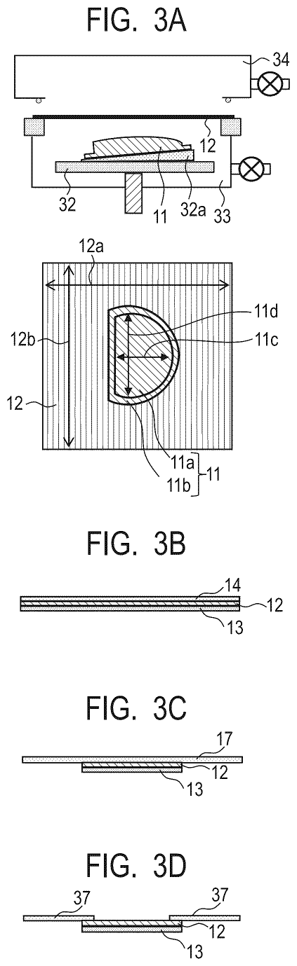

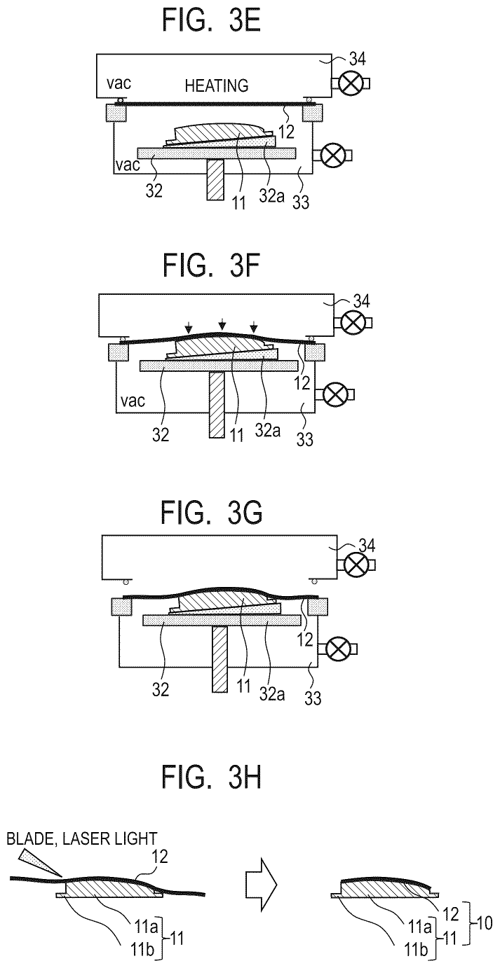

The reflective polarizing film 12 is bonded to the curved surface of the curved surface portion in the substrate through intermediation of a pressure-sensitive adhesive layer 13 (see FIG. 3B). The reflective polarizing film 12 is not particularly limited, but, as described above, is formed of a sheet A and a sheet B that are two layers made of different materials, and is created by alternately laminating those films made of different materials for several hundreds of layers and extending the film in a certain direction. As illustrated in FIG. 1, the reflective polarizing film 12 has a reflection axis 12a and a transmission axis 12b orthogonal to the reflection axis 12a, and can reflect light that has entered the reflective polarizing film 12 in parallel to the reflection axis 12a without transmitting the light. The direction of the reflection axis 12a and the direction of the transmission axis 12b can be checked by, as an example, causing light polarized in one direction to enter the film in a spectrophotometer.

In the reflective polarizing film 12, a film extension rate varies between the direction of the reflection axis 12a and the direction of the transmission axis 12b. Specifically, the reflective polarizing film 12 is less likely to be extended in the direction of the reflection axis 12a than in the direction of the transmission axis 12b. The reflective polarizing film 12 is provided on the curved surface of the curved surface portion 11a while being extended as described later. Further, in the reflective polarizing optical element 10 illustrated in FIG. 1, the reflection axis 12a is arranged so as to be parallel to the extension direction of the short diameter 11c.

With the reflection axis 12a and the extension direction of the short diameter 11c being arranged in parallel to each other as described above, when the reflective polarizing film 12 is bonded to the substrate 11, the length of the curved surface portion 11a in the direction of the reflection axis 12a in which the reflective polarizing film 12 is less likely to be extended is reduced. Accordingly, at the time of bonding the reflective polarizing film 12, also in the direction of the reflection axis 12a in which the reflective polarizing film 12 is less likely to be extended, the film can be bonded to the curved surface portion of the substrate even when the extension amount of the reflective polarizing film 12 is small. Accordingly, a region that has a possibility of occurrence of separation in the reflective polarizing film 12 is provided outside of the curved surface portion 11a of the substrate 11. In this manner, in the reflective polarizing optical element 10 according to this embodiment, the possibility of occurrence of separation of the reflective polarizing film 12 in the curved surface portion 11a can be reduced.

In order to reliably reduce the separation of the reflective polarizing film 12, it is preferred that the reflective polarizing film 12 be arranged so that, in plan view as viewed in the optical axis direction of the substrate 11, the reflection axis 12a and the short diameter 11c of the curved surface portion 11a be parallel to each other. However, in the case of the substrate shape exemplified in FIG. 2B or FIG. 2C, there may be caused a mismatch between the direction in which the extension is reduced and the extension direction of the short diameter 11c in consideration of extension from a position corresponding to the reference point of the reflective polarizing film 12 to a substrate end portion. In contrast, in the design of the reflective polarizing optical element 10, the reflective polarizing film 12 is arranged and bonded to the substrate so that an angle formed between the reflection axis 12a and the extension direction of the short diameter 11c becomes 30° or less. It is found that such structure can reduce excessive extension of the reflective polarizing film 12. That is, when the angle formed between the reflection axis 12a and the extension direction of the short diameter 11c is larger than 30°, the length of the curved surface portion 11a in the direction of the reflection axis 12a is increased, resulting in excessive extension of the reflective polarizing film 12. Thus, the effect of this embodiment cannot be expected.

Here, for example, in the reflective polarizing optical element 10 of FIG. 1, a curvature radius of a curved surface of the curved surface portion 11a to which the reflective polarizing film 12 is to be bonded is represented by R, and a length of the long diameter 11d of the curved surface portion 11a is represented by L2. At this time, a half aperture angle θ of the curved surface of the curved surface portion 11a is defined by Expression 1 given below. When the curved surface of the curved surface portion 11a is an aspherical surface, as the curvature radius R, an optimal value, an approximate value, or the like obtained through optimal fitting using the least squares method can be used.

sin θ=(L2/2)/R (Expression 1)

The half aperture angle θ may be set as appropriate depending on, for example, the design of the substrate 11 functioning as a lens, but is preferably 0°<θ≤30° from the viewpoint of the substrate 11 functioning as a lens.

Further, when a length of the short diameter 11c of the curved surface portion 11a is represented by L1 and an angle formed between the reflection axis 12a and the short diameter 11c is represented by φ, it is preferred that the length L1 of the short diameter 11c and the length L2 of the long diameter 11d satisfy Expression 2 given below, provided that the half aperture angle θ is in a range of 5°≤θ≤30°.

0.2≤(L1/cos φ)/L2≤−0.0128×θ+0.982 (Expression 2)

Expression 2 represents that, as the half aperture angle θ becomes larger, the reflective polarizing film 12 is required to be bonded while being further extended, and, in order to suppress the separation of the reflective polarizing film 12, it is preferred that a ratio of the length L1 of the short diameter 11c to the length L2 of the long diameter 11d be reduced. That is, Expression 2 represents that it is preferred that, as the half aperture angle θ becomes larger, the length L1 of the short diameter 11c become shorter.

Next, a method of manufacturing the reflective polarizing optical element 10 according to this embodiment is described with reference to FIG. 3A to FIG. 3H. The view on the upper side in FIG. 3A and FIG. 3E to FIG. 3H are explanatory views for illustrating the method of manufacturing the reflective polarizing optical element 10 according to this embodiment, and are sectional views for illustrating schematic configurations of a manufacturing device and the substrate 11 and the like held in the manufacturing device. Here, a case in which the substrate 11 and the like exemplified in FIG. 1 are used is described. The view on the lower side in FIG. 3A is a plan view for illustrating the substrate 11 and the reflective polarizing film 12 in a case in which, in a step illustrated in the view on the upper side in FIG. 3A and the like, the reflective polarizing film 12 and the like are viewed from a second chamber 34 in a direction perpendicular to the film surface. FIG. 3B to FIG. 3D are sectional views for illustrating examples of the mode of the reflective polarizing film 12 when the reflective polarizing film 12 is bonded to the substrate 11.

As illustrated in FIG. 3A and others, the manufacturing device used in this embodiment includes a first chamber 33, the second chamber 34, and a stage 32. The first chamber 33 and the second chamber 34 can each independently exhaust the inside thereof to reduce the pressure. In an upper portion of the first chamber 33 and a corresponding lower portion of the second chamber 34, opening portions which can be connected to each other are provided. An example in which those chambers are arranged in the vertical direction is given here, but this arrangement is exemplary. The chambers can be arranged laterally or in an arrangement turned upside down.

In an actual film bonding step, first, as illustrated in FIG. 3A, in the first chamber 33, the substrate 11 having the short diameter 11c and the long diameter 11d is arranged. The substrate 11 is arranged on the stage 32 including a raising/lowering mechanism in the first chamber 33. The second chamber 34 is arranged above the first chamber 33. The reflective polarizing film 12 is arranged between the first chamber 33 and the second chamber 34 which are connected to each other via the above-mentioned opening portions. At this time, the reflective polarizing film 12 is arranged to face the substrate 11.

With reference to FIG. 3B to FIG. 3D, the pressure-sensitive adhesive layer 13 and the like used together with the reflective polarizing film 12 at the time of bonding the reflective polarizing film 12 to the substrate 11 are described. FIG. 3B to FIG. 3D schematically show the cross sections of the reflective polarizing film 12 and the like. As illustrated in FIG. 3B to FIG. 3D, a uniform pressure-sensitive adhesive layer 13 can be provided on the surface of the reflective polarizing film 12 on the substrate 11 side. Further, a protective film 14 can be provided on the surface of the reflective polarizing film 12 (on a surface opposite to the surface on which the pressure-sensitive adhesive layer 13 is to be formed). In this case, it is preferred that the glass transition temperature of the protective film 14 be lower than the glass transition temperature of the reflective polarizing film 12. Through use of such a protective film 14, the usage strength of the reflective polarizing film 12 is increased, and tearing or the like of the reflective polarizing film 12 is less liable to occur when the substrate 11 is bonded.

Further, the reflective polarizing film 12 is expensive as compared to a general film. Accordingly, from the viewpoint of reducing the manufacturing cost, it is inappropriate to use a reflective polarizing film 12 having a size excessively larger than the area of the curved surface portion 11a of the substrate 11. That is, the reflective polarizing film 12 is only required to have a size slightly larger than the substrate 11. Specifically, for example, the reflective polarizing film 12 is only required to have an area that is from 1.5 times to 2.5 times the area of the curved surface portion 11a in plan view as viewed in the optical axis direction of the substrate 11.

Here, when the size of the reflective polarizing film 12 is reduced as much as possible, at the time of holding the reflective polarizing film 12 between the first chamber 33 and the second chamber 34, it is required to, for example, secure also the size required for this holding. Accordingly, as illustrated in FIG. 3C, on the reflective polarizing film 12, a support film 17 formed of a member separate from the reflective polarizing film 12 may be bonded. At this time, in order to obtain a uniform film warpage at the time of heating the film, it is preferred that the glass transition temperature of the support film 17 be a temperature equivalent to or lower by about 20° C. than the glass transition temperature of the reflective polarizing film 12.

Further, as illustrated in FIG. 3D, a support film 37 may be bonded only to the outer peripheral portion of the reflective polarizing film 12. The support films 17 and 37 can be separated from the reflective polarizing film 12 at an appropriate timing after the reflective polarizing film 12 is bonded to the substrate 11.

In a bonding step of bonding the reflective polarizing film 12, the above-mentioned film is held between the first chamber 33 and the second chamber 34. At this time, the substrate 11 can be arranged while being inclined so that a tangent line at a center point of the short diameter 11c of the curved surface portion 11a in the substrate 11 becomes parallel to the reflective polarizing film 12. A unit for arranging the substrate 11 in an inclined manner is not particularly limited. For example, a base 32a having an inclined surface may be installed on the stage 32 for holding the substrate 11, and the substrate 11 can be arranged in an inclined manner by arranging the substrate 11 on the inclined surface. Further, in place of arranging the substrate 11 in an inclined manner, the reflective polarizing film 12 may be arranged in an inclined manner so that the tangent line at the center point of the short diameter 11c of the curved surface portion 11a becomes parallel to the reflective polarizing film 12.

In this manner, the reflective polarizing film 12 can be bonded to the curved surface portion 11a more equally. Further, the reflective polarizing film 12 in a state in which separation has occurred can be more reliably prevented from being bonded to the curved surface portion 11a of the substrate 11, and the possibility of occurrence of separation of the reflective polarizing film 12 can be further reduced.

Next, as illustrated in FIG. 3E, the opening portion of the first chamber 33 and the opening portion of the second chamber 34 are connected to each other so that the reflective polarizing film 12 is interposed between both of the opening portions. Subsequently, the inside of the first chamber 33 and the inside of the second chamber 34 are exhausted to be vacuumized, and the reflective polarizing film 12 is heated. Here, the method of heating the reflective polarizing film 12 is not particularly limited, and examples of the method include a method of using an infrared heater for directly heating the reflective polarizing film 12, and a method of heating the entire first chamber 33 and second chamber 34 by a heater or the like. However, in the case of the latter method, the substrate 11 is also heated. When the substrate 11 is heated, in particular, in a case in which the material of the substrate 11 is plastic, there is a fear of deformation of the substrate 11 due to heat. Accordingly, when the substrate 11 is heated, it is important to form the base 32a and the like of the substrate 11 so as to have a heat insulated structure, and it is preferred that the temperature of the substrate 11 be kept to 120° C. or less regardless of the temperature of the reflective polarizing film 12.

Next, after the reflective polarizing film 12 is heated to a desired temperature, as illustrated in FIG. 3F, through use of the stage 32 having the raising/lowering function, the position of the substrate 11 is raised until the curved surface portion 11a of the substrate 11 is brought into contact with the pressure-sensitive adhesive layer 13 of the reflective polarizing film 12. Subsequently, only the inside of the second chamber 34 is opened to atmosphere so that the pressure in the second chamber 34 is increased, and, as required, a high-pressure gas is supplied into the second chamber 34 so that the reflective polarizing film 12 is pressurized to be pressed against the substrate 11 including the curved surface portion 11a. In this manner, the reflective polarizing film 12 is bonded to the curved surface of the curved surface portion 11a of the substrate 11. The reflective polarizing film 12 is pressed against the curved surface portion 11a to be extended and provided on the curved surface of the curved surface portion 11a. As required, the heating and pressurizing of the reflective polarizing film 12 may be continued for a certain time period.

Here, in the substrate 11, the step portion 11e is provided at the boundary at least on the short diameter 11c side between the curved surface portion 11a and the peripheral edge portion 11b. At least a part of the reflective polarizing film 12 to be bonded to the curved surface portion 11a can also be bonded to the step portion 11e. When the reflective polarizing film 12 is bonded to the substrate 11 under such a state, the separation of the reflective polarizing film can be suppressed. Further, in addition, an effect of reducing peeling of the film in a durability test under high temperature can be obtained as a side effect. The range in which the reflective polarizing film 12 is bonded to the step portion 11e is only required to reach, for example, a range of 30° or more from the short diameter about an end portion of the curved surface portion 11a corresponding to the short diameter. When the range is smaller than 30°, there is a possibility of being incapable of sufficiently covering the range in which the separation may occur in the reflective polarizing film 12. With the reflective polarizing film 12 being bonded to the step portion 11e up to this range or a range larger than this range, the effect of reducing the peeling of the film in the durability test under the high temperature can be obtained as a side effect.

Next, as illustrated in FIG. 3G, the heating and pressurizing of the reflective polarizing film 12 are stopped and the inside of the second chamber 34 is restored to the atmospheric pressure, and then the inside of the first chamber 33 is also opened to atmosphere. After that, the reflective polarizing film 12 and the substrate 11 having the reflective polarizing film 12 bonded thereto are taken out from the first chamber 33 and the second chamber 34.

Subsequently, as illustrated in FIG. 3H, only the reflective polarizing film 12 on the curved surface portion 11a of the substrate 11 is left, and the unrequired reflective polarizing film 12 is cut together with the pressure-sensitive adhesive layer 13. As the cutting method, a method of cutting the unrequired reflective polarizing film 12 by putting a blade on the reflective polarizing film 12 along an outer edge of the curved surface portion 11a can be used. Further, a method of cutting the unrequired reflective polarizing film 12 by applying laser light to the reflective polarizing film 12 along the outer edge of the curved surface portion 11a can also be used. Those cutting methods are exemplary, and other publicly-known methods may be used. Through the above-mentioned steps, the reflective polarizing optical element 10 in which the reflective polarizing film 12 is bonded to the curved surface portion 11a of the substrate 11 can be manufactured.

The method of manufacturing the reflective polarizing optical element 10 is not limited to the above-mentioned manufacturing method illustrated in FIG. 3A to FIG. 3H, and the reflective polarizing optical element 10 can be manufactured by other manufacturing methods. That is, it is only required that, in the reflective polarizing optical element 10 after the manufacture, the angle formed between the reflection axis 12a and the short diameter of the curved surface portion 11a passing through the reference point be 30° or less. When the reflective polarizing optical element 10 satisfies this condition, the occurrence of separation of the reflective polarizing film 12 from the substrate 11 can be reduced, and the peeling of the film can be reduced.

Here, an example of another manufacturing method is described. For example, as in Example 8 described later, the reflective polarizing optical element 10 can also be manufactured by, after bonding the reflective polarizing film 12 to the curved surface portion of the substrate having no distinction between the short diameter and the long diameter, cutting off a predetermined end portion including the curved surface portion 11a of the substrate 11. In this case, first, for example, in the case of the reflective polarizing optical element 10 exemplified in FIG. 1, a substrate including a curved surface portion having an axisymmetric planar shape such as a perfect circular shape is arranged and prepared. The curved surface portion has no distinction between the short diameter 11c and the long diameter 11d in plan view as viewed in the optical axis direction of the substrate 11. Next, the reflective polarizing film 12 is bonded to the curved surface of the curved surface portion. The bonding of the reflective polarizing film 12 can be performed similarly to the case of the above-mentioned manufacturing method.

Next, in a direction in which an angle formed with the reflection axis 12a of the reflective polarizing film 12 becomes 30° or less in plan view as viewed in the optical axis direction of the substrate, here, in a direction parallel to the reflection axis 12a, at least one end portion of the substrate is cut off together with the reflective polarizing film 12 bonded to the end portion. At this time, a peripheral edge portion is provided in the cut part. Even with the above-mentioned steps, the reflective polarizing optical element 10 exemplified in FIG. 1 can be manufactured.

Now, Examples in each of which the reflective polarizing optical element according to this embodiment was actually manufactured are described below. In Examples described below, the reflective polarizing optical element is evaluated through, for example, observation of an end portion state by a microscope. Specifically, a region located inward by 2 mm from the outer circumference of the curved surface portion of the substrate is observed, and, when separation of 200 μm or more in width cannot be observed, the reflective polarizing optical element is evaluated as being satisfactory because there is no influence on peeling in a durability test under a high-temperature environment. The observation by the microscope can be performed through use of, as a specific example, for example, Digital Microscope VHX (manufactured by Keyence Corporation). Moreover, as the durability test under the high temperature, a temperature cycling test of 70° C. for 30 minutes and −30° C. for 30 minutes was repeated for 30 cycles. Then, the reflective polarizing optical element 10 after the end of the durability test was subjected to observation of the end portion state by the microscope, and whether peeling progressed to the region distant by 2 mm or more from the outer circumference was checked.

### Example 1

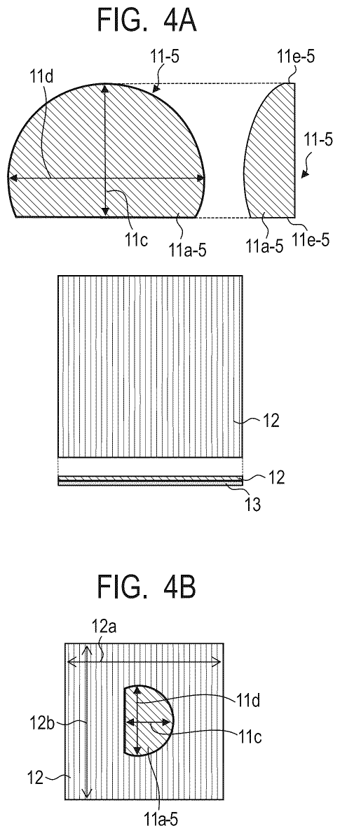

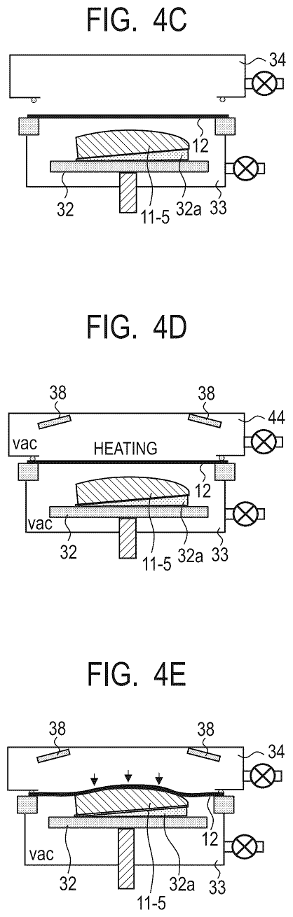

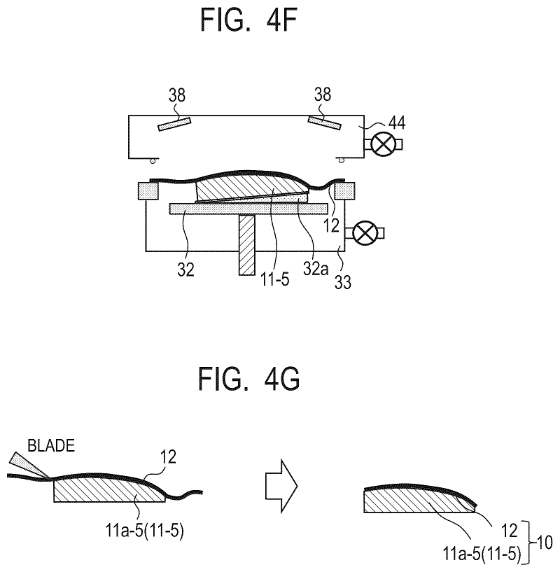

A reflective polarizing optical element 10 and a method of manufacturing the reflective polarizing optical element 10 according to Example 1 of the present disclosure are described with reference to FIG. 4A to FIG. 4G. First, in Example 1 described below, a substrate 11-5 formed of plastic containing cyclic olefin copolymer (COC) as a main component was used. The substrate 11-5 was molded by injection molding. The two views on the upper side in FIG. 4A show the substrate 11-5 used in Example 1. The view on the left side is a plan view of the substrate 11-5 in plan view as viewed in the optical axis direction, and the view on the right side is a sectional view for illustrating a cross section of the substrate 11-5 taken along the short diameter 11c. As illustrated in FIG. 4A, the substrate 11-5 is a convex lens in which a length L1 of a short diameter 11c of a curved surface portion 11a-5 is 36 mm, a length L2 of a long diameter 11d is 50 mm, and a half aperture angle θ is 20°. Further, a step portion 11e-5 is provided at the outer circumference of the curved surface portion 11a-5, and the height of the lowest step is 2 mm. Further, the substrate 11-5 in this Example includes no peripheral edge portion.

In this Example, an image quality polarizer enhanced (IQPE) film manufactured by 3M Company was used as the reflective polarizing film 12. The two views on the lower side in FIG. 4A exemplify the reflective polarizing film 12 used in Example 1. The view on the upper side is a plan view for illustrating the reflective polarizing film 12 in plan view as viewed in a direction perpendicular to the film surface, and the view on the lower side is a sectional view for illustrating a cross section of the reflective polarizing film 12 taken along the reflection axis 12a. The reflective polarizing film 12 illustrated in FIG. 4A is a reflective polarizing film having a square planar shape of 100 mm×100 mm and having a thickness of about 0.07 mm, and has one surface provided with the pressure-sensitive adhesive layer 13. FIG. 4B is a plan view for illustrating the substrate 11-5 and the reflective polarizing film 12 in a step illustrated in FIG. 4C to be described later, and is a plan view as viewed in the direction perpendicular to the film surface of the reflective polarizing film 12.

FIG. 4C to FIG. 4G are sectional views for illustrating the method of manufacturing the reflective polarizing optical element 10 according to Example 1 in a mode similar to that of FIG. 3A and FIG. 3E to FIG. 3H. Configurations exhibiting functions similar to those of the respective configurations of the manufacturing device described with reference to FIG. 3A and others are denoted by the same reference symbols, and description thereof is omitted here.

Regarding the substrate 11 and the reflective polarizing film 12 which have been described above, as illustrated in FIG. 4C, the substrate 11-5 is arranged in the first chamber 33, and the reflective polarizing film 12 is arranged between the first chamber 33 and the second chamber 34. At this time, the reflective polarizing film 12 was arranged so that the pressure-sensitive adhesive layer 13 was directed to the substrate 11-5 side to face the substrate 11-5. Further, the substrate 11-5 was arranged in an inclined manner so that the tangent line at the center point of the short diameter 11c became parallel to the reflective polarizing film 12. Further, the substrate 11-5 was arranged so that, as illustrated in FIG. 4C, the short diameter 11c of the curved surface portion 11a-5 of the substrate 11 and the reflection axis 12a of the reflective polarizing film 12 were substantially parallel to each other (an angle φ was 0°, that is, the angle φ fell within ±2°).

Next, as illustrated in FIG. 4D, the inside of the first chamber 33 and the inside of the second chamber 34 were exhausted to be vacuumized. After that, the reflective polarizing film 12 arranged so as to be interposed between the first chamber 33 and the second chamber 34 was heated by an infrared heater 38.

The heating by the infrared heater 38 was continued until the reflective polarizing film 12 reached 100° C. After that, as illustrated in FIG. 4E, through use of the stage 32, the substrate 11-5 was raised until the curved surface portion 11a-5 was brought into contact with the pressure-sensitive adhesive layer 13 of the reflective polarizing film 12. Subsequently, only the inside of the second chamber 34 was opened to atmosphere. After that, compressed air was caused to flow into the second chamber 34 to increase the pressure inside of the second chamber 34 up to 0.3 MPa, and the reflective polarizing film 12 was pressurized to be pressed against the substrate 11 for 10 seconds. After that, as illustrated in FIG. 4F, after the heating and the pressurizing of the reflective polarizing film 12 were stopped so that the second chamber 34 was restored to the atmospheric pressure, the first chamber 33 was also opened to atmosphere.

After the first chamber 33 was opened to atmosphere, the reflective polarizing film 12 and the substrate 11-5 having the reflective polarizing film 12 bonded thereto were taken out from the first chamber 33 and the second chamber 34.

Subsequently, as illustrated in FIG. 4G, the unrequired reflective polarizing film 12 was cut together with the pressure-sensitive adhesive layer 13 by putting a blade on the reflective polarizing film 12 along the outer edge of the curved surface portion 11a-5 so as to leave only the reflective polarizing film 12 on the curved surface portion 11a-5 of the substrate 11-5. As described above, a reflective polarizing optical element 10-5 in which the reflective polarizing film 12 was bonded to the curved surface portion 11a-5 of the substrate 11-5 was manufactured.

The reflective polarizing optical element 10-5 of Example 1 was subjected to observation of a region distant by 2 mm from the outer circumference of the curved surface portion 11a-5 of the substrate 11-5 through use of an optical microscope VHX for evaluation of separation and the like. As a result, no separation of 200 μm or more in width was observed in the curved surface portion 11a-5 of the substrate 11-5. Moreover, observation was also performed after the temperature cycling test, and it was confirmed that no peeling had progressed to the region distant by 2 mm or more from the outer circumference of the curved surface portion 11a-5 of the substrate 11-5. Accordingly, the reflective polarizing optical element 10 of Example 1 was evaluated as being satisfactory regarding the separation and the like as shown later in Tables 1-1 and 1-2.

### Example 2

In Example 2, in the shape of the substrate 11-5 exemplified in FIG. 4A in Example 1, the length of the short diameter, the length of the long diameter, and the half aperture angle were changed. Specifically, there was used, as the substrate, a convex lens in which the length L1 of the short diameter 11c of the curved surface portion was 46 mm, the length L2 of the long diameter 11d was 50 mm, and the half aperture angle θ of the curved surface portion was 5°. Also in Example 2, the reflective polarizing optical element was manufactured by a method similar to that in Example 1 except that the dimensions and the like in the shape of the substrate 11-5 were changed.

Even for the reflective polarizing optical element of Example 2, evaluation similar to that for the reflective polarizing optical element 10 of Example 1 was performed. As a result, in the curved surface portion of the substrate, no separation of 200 μm or more in width was observed. Further, observation was also performed after the temperature cycling test, and it was confirmed that no peeling had progressed to the region distant by 2 mm or more from the outer circumference of the curved surface portion of the substrate. Accordingly, the reflective polarizing optical element of Example 2 was evaluated as being satisfactory regarding the separation and the like as shown in Tables 1-1 and 1-2.

### Example 3

In Example 3, in the shape of the substrate 11-5 exemplified in FIG. 4A in Example 1, the length of the short diameter, the length of the long diameter, and the half aperture angle were changed. Specifically, there was used, as the substrate, a convex lens in which the length L1 of the short diameter 11c of the curved surface portion was 40 mm, the length L2 of the long diameter 11d was 50 mm, and the half aperture angle θ of the curved surface portion was 30°. Also in Example 3, the reflective polarizing optical element was manufactured by a method similar to that in Example 1 except that the dimensions and the like in the shape of the substrate 11-5 were changed.

Even for the reflective polarizing optical element of Example 3, evaluation similar to that for the reflective polarizing optical element 10 of Example 1 was performed. As a result, in the curved surface portion of the substrate, no separation of 200 μm or more in width was observed. Further, observation was also performed after the temperature cycling test, and it was confirmed that no peeling had progressed to the region distant by 2 mm or more from the outer circumference of the curved surface portion of the substrate. Accordingly, the reflective polarizing optical element of Example 3 was evaluated as being satisfactory regarding the separation and the like as shown in Tables 1-1 and 1-2.

### Example 4

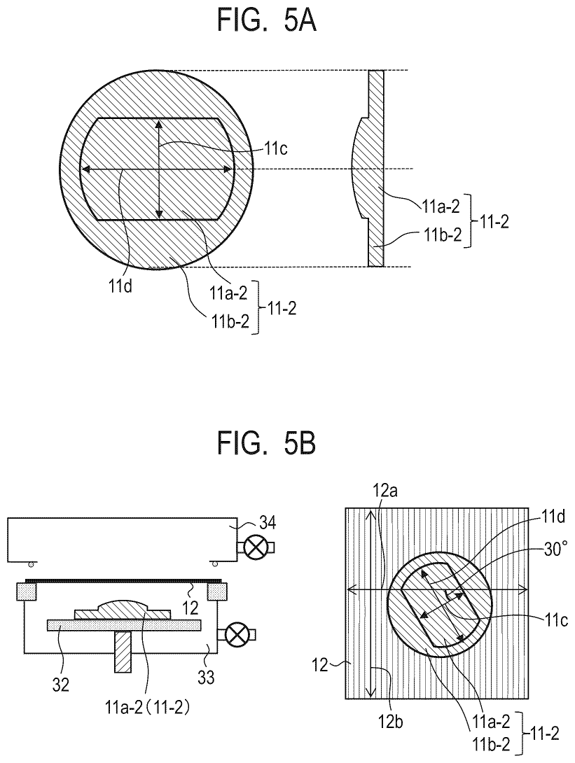

In Example 4, the shape of the substrate was changed to the shape exemplified in FIG. 2A. Specifically, as exemplified in FIG. 5A having a mode similar to that of FIG. 2A, there was used, as the substrate 11-2, a convex lens in which the length L1 of the short diameter 11c of the curved surface portion 11a-2 was 25 mm, the length L2 of the long diameter 11d was 50 mm, and the half aperture angle θ of the curved surface portion 11a-2 was 20°. Further, a flat region having an outer diameter of 56 mm was provided as the peripheral edge portion 11b-2.

Next, a method of manufacturing a reflective polarizing optical element 10-2 in this Example is described. The view on the left side and the view on the right side in FIG. 5B correspond to the view on the upper side and the view on the lower side in FIG. 3A, respectively. The view on the left side in FIG. 5B is a sectional view for illustrating the method of manufacturing the reflective polarizing optical element 10-2 of Example 4. Thus, configurations exhibiting functions similar to those of the respective configurations of the manufacturing device described above are denoted by the same reference symbols, and description thereof is omitted here. In this Example, the view on the right side in FIG. 5B is a plan view for illustrating the substrate 11-2 and the reflective polarizing film 12, and is a plan view as viewed in the direction perpendicular to the film surface of the reflective polarizing film 12.

In Example 4, as illustrated in FIG. 5B, the substrate 11-2 was arranged in the first chamber 33, and the reflective polarizing film 12 was arranged between the first chamber 33 and the second chamber 34. At this time, the reflective polarizing film 12 was arranged so that the pressure-sensitive adhesive layer 13 was directed toward the substrate 11-2 side to face the substrate 11-2. Further, the substrate 11-2 was arranged on the stage 32 without using the base 32a and without being inclined. Moreover, the substrate 11-2 was arranged so that the angle φ formed between the short diameter 11c of the curved surface portion 11a-2 and the reflection axis 12a of the reflective polarizing film 12 became 30°. Also in Example 4, the reflective polarizing optical element 10-2 was manufactured by a method similar to that in Example 3 except that the shape of the substrate 11-2 was changed, and the angle φ formed between the short diameter 11c of the curved surface portion 11a-2 and the reflection axis 12a of the reflective polarizing film 12 was set to 30°.

Even for the reflective polarizing optical element 10-2 of Example 4, evaluation similar to that for the reflective polarizing optical element 10-5 of Example 1 was performed. As a result, in the curved surface portion 11a-2 of the substrate 11-2, no separation of 200 μm or more in width was observed. Further, observation was also performed after the temperature cycling test, and it was confirmed that no peeling had progressed to the region distant by 2 mm or more from the outer circumference of the curved surface portion 11a-2 of the substrate 11-2. Accordingly, the reflective polarizing optical element 10-2 of Example 4 was evaluated as being satisfactory regarding the separation and the like as shown in Tables 1-1 and 1-2.

### Example 5

In Example 5, in the shape of the substrate 11-5 exemplified in FIG. 4A in Example 1, the length of the short diameter, the length of the long diameter, and the half aperture angle were changed. Specifically, there was used a concave lens in which the length L1 of the short diameter 11c of the curved surface portion was 36 mm, the length L2 of the long diameter 11d was 50 mm, and the half aperture angle θ of the curved surface portion was 20°. Also in Example 5, the reflective polarizing optical element was manufactured by a method similar to that in Example 1 except that the shape of the substrate 11-5 was set to a concave lens and the dimensions and the like were changed.

Even for the reflective polarizing optical element of Example 5, evaluation similar to that for the reflective polarizing optical element 10 of Example 1 was performed. As a result, in the curved surface portion of the substrate, no separation of 200 μm or more in width was observed. Further, observation was also performed after the temperature cycling test, and it was confirmed that no peeling had progressed to the region distant by 2 mm or more from the outer circumference of the curved surface portion of the substrate. Accordingly, the reflective polarizing optical element of Example 5 was evaluated as being satisfactory regarding the separation and the like as shown in Tables 1-1 and 1-2.

### Example 6

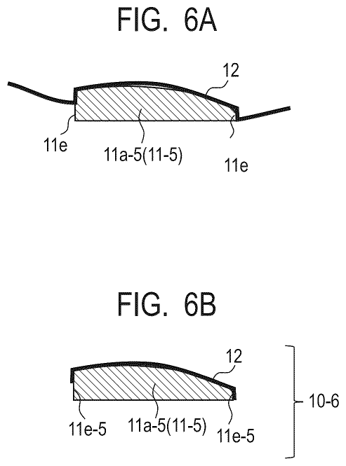

In Example 6, there was used a substrate having a shape similar to that of the substrate 11-5 exemplified in FIG. 4A in Example 1. Then, the reflective polarizing film 12 was heated to 120° C., and the reflective polarizing film 12 in this state was bonded to the substrate 11-5. With the film temperature at the time of bonding being increased to 120° C., the reflective polarizing film 12 is more softened, and thus suitable bonding can be achieved. The states of the substrate 11-5 and the reflective polarizing film 12 at the time of this bonding are illustrated in FIG. 6A as a schematic sectional view. As illustrated in FIG. 6A, the reflective polarizing film 12 can be bonded up to a step portion 11e-5 of the substrate 11-5. Next, the unrequired reflective polarizing film 12 was cut together with the pressure-sensitive adhesive layer 13 as illustrated in FIG. 6B by putting a blade on the reflective polarizing film 12 so as to leave only the reflective polarizing film 12 bonded to the curved surface portion 11a-5 and the step portion 11e-5 of the substrate 11-5. The reflective polarizing optical element was manufactured by a method similar to that in Example 1 except the temperature at the time of bonding and the mode of cutting the film as described above.

Even for a reflective polarizing optical element 10-6 of Example 6, evaluation similar to that for the reflective polarizing optical element 10 of Example 1 was performed. As a result, the reflective polarizing film 12 was bonded not only to the curved surface portion 11a-5 of the substrate 11-5 but also to the step portion 11e-5, and, in the curved surface portion 11a-5 of the substrate 11-5, no separation of 200 μm or more in width was observed. Moreover, no separation of 100 μm or more in width was also observed. Further, observation was also performed after the temperature cycling test, and it was confirmed that no peeling had progressed to the region distant by 2 mm or more from the outer circumference of the curved surface portion 11a-5 of the substrate 11-5. Accordingly, the reflective polarizing optical element 10-6 of Example 6 was evaluated as being more satisfactory regarding the separation and the like than the reflective polarizing optical element exemplified in Example 1 as shown in Tables 1-1 and 1-2.

### Example 7

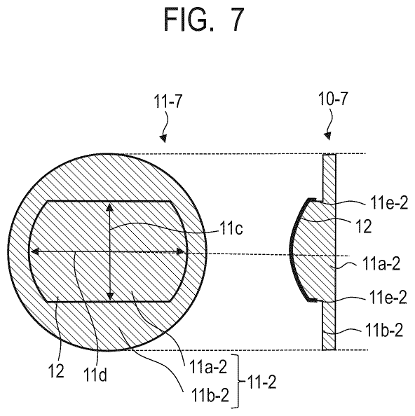

In Example 7, in the shape of the substrate 11-2 exemplified in FIG. 5A in Example 4, the length of the short diameter, the length of the long diameter, and the half aperture angle were changed. Specifically, there was used, as the substrate, a convex lens in which the length L1 of the short diameter 11c of the curved surface portion 11a-2 was 36 mm, the length L2 of the long diameter 11d was 50 mm, and the half aperture angle θ of the curved surface portion 11a-2 was 20°. Further, the flat peripheral edge portion 11b-2 was provided at the outer circumference of the curved surface portion 11a-2. The peripheral edge portion 11b-2 was concentric with the center of the curved surface portion 11a-2 and had an outer diameter of 56 mm. Further, between the curved surface portion 11a-2 and the peripheral edge portion 11b-2, in straight-line parts at both ends of the short diameter 11c, a step portion 11e-2 having a height of 3 mm was provided. A reflective polarizing optical element 10-7 was manufactured by a method similar to that in Example 6 except that the shape of the substrate was changed as described above. The manufactured reflective polarizing optical element 10-7 is illustrated in FIG. 7 in a state of being schematically illustrated in a mode similar to that of FIG. 5A.

Even for the reflective polarizing optical element 10-7 of Example 7, evaluation similar to that for the reflective polarizing optical element 10-5 of Example 1 was performed. As a result, the reflective polarizing film 12 was bonded not only to the curved surface portion 11a-2 of the substrate 11-2 but also to the step portion 11e-2, and, in the curved surface portion 11a-2 of the substrate 11-2, no separation of 200 μm or more in width was observed. Moreover, no separation of 100 μm or more in width was also observed. Further, observation was also performed after the temperature cycling test, and it was confirmed that no peeling had progressed to the region distant by 2 mm or more from the outer circumference of the curved surface portion 11a-2 of the substrate 11-2. Accordingly, the reflective polarizing optical element 10-7 of Example 7 was evaluated as being more satisfactory regarding the separation and the like than the reflective polarizing optical element exemplified in Example 1 as shown in Tables 1-1 and 1-2.

### Example 8

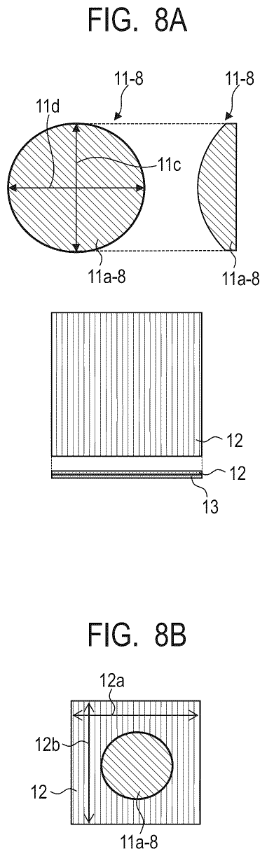

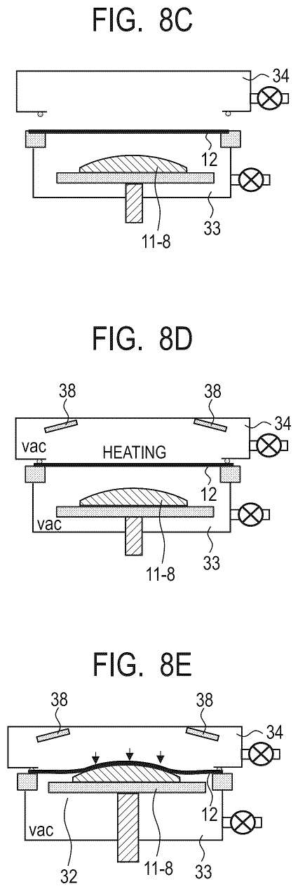

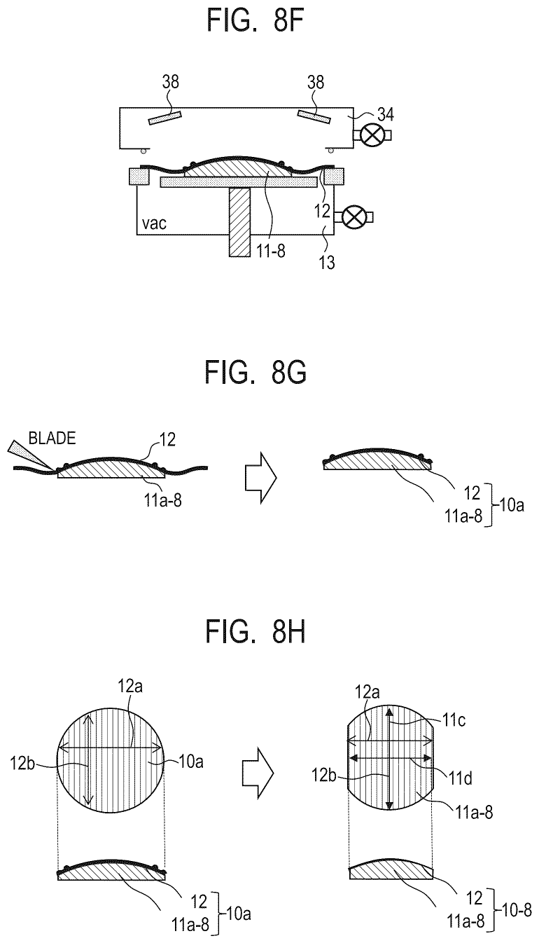

In Example 8, a substrate 11-8 having a shape as illustrated in FIG. 8A was used. The two views on the upper side in FIG. 8A are views for schematically illustrating the substrate 11-8. The view on the left side is a plan view of the substrate 11-8 in plan view as viewed in the optical axis direction, and the view on the right side is a sectional view for illustrating a cross section of the substrate 11-8 taken along the short diameter 11c. As illustrated in FIG. 8A, the substrate 11-8 is formed of a convex lens in which, in plan view, a curved surface portion 11a-8 has a circular shape in which the length L1 of the short diameter 11c and the length L2 of the long diameter 11d are the same, specifically, 50 mm, and the half aperture angle θ is 20°. Further, in the substrate 11-8, no peripheral edge portion is provided.

Meanwhile, there was used, as the reflective polarizing film 12, a reflective polarizing film similar to that of Example 1 as illustrated in the two views on the lower side in FIG. 8A. The two views on the lower side in FIG. 8A are views for schematically illustrating the reflective polarizing film 12 used in Example 8. The view on the upper side is a plan view in which the reflective polarizing film 12 is viewed in a direction perpendicular to the film surface, and the view on the lower side is a sectional view for illustrating the cross section of the reflective polarizing film 12 taken along the reflection axis 12a. The reflective polarizing film 12 used in this Example is provided with the pressure-sensitive adhesive layer 13 in the entire region of the rear surface.

Next, with reference to FIG. 8C to FIG. 8H, a method of manufacturing a reflective polarizing optical element 10-8 according to this Example is described. FIG. 8C to FIG. 8G show respective steps of the method of manufacturing the reflective polarizing optical element 10-8 according to this Example in a mode similar to that of the steps given in the description regarding the process of manufacturing the reflective polarizing optical element 10 exemplified in Example 1. That is, FIG. 8C to FIG. 8G are schematic sectional views for illustrating the steps of the method of manufacturing the reflective polarizing optical element 10-8. Further, FIG. 8B is a plan view for illustrating the positional relationship between the substrate 11-8 and the reflective polarizing film 12 in the step illustrated in FIG. 8C, and is a plan view as viewed in the direction perpendicular to the film surface of the reflective polarizing film 12. FIG. 8H is an explanatory view for illustrating the final step in the method of manufacturing the reflective polarizing optical element 10-8 in this Example, and shows a plan view and a sectional view of the reflective polarizing optical element 10-8 before and after the final step.

At the time of manufacturing the reflective polarizing optical element 10-8, in this Example, first, as illustrated in FIG. 8C, the above-mentioned substrate 11-8 was arranged in the first chamber 33. Further, the reflective polarizing film 12 was arranged between the first chamber 33 and the second chamber 34. At this time, the reflective polarizing film 12 was arranged so that the pressure-sensitive adhesive layer 13 was directed toward the substrate 11-8 side to face the substrate 11-8. Further, the substrate 11-8 had a rear surface that was a flat surface perpendicular to the optical axis, and hence the substrate 11-8 was arranged on the stage 32 without being inclined and without using the base 32a used in Example 1. The direction of the reflection axis 12a of the reflective polarizing film 12 is not particularly designated in this Example.

Next, as illustrated in FIG. 8D, the inside of the first chamber 33 and the inside of the second chamber 34 were exhausted to be vacuumized. Then, the reflective polarizing film 12 arranged so as to be interposed between the first chamber 33 and the second chamber 34 was heated with the infrared heater 38.

After the reflective polarizing film 12 was heated to 100° C., as illustrated in FIG. 8E, through use of the stage 32, the position of the substrate 11-8 was raised until the curved surface portion 11a-8 of the substrate 11-8 was brought into contact with the pressure-sensitive adhesive layer 13 of the reflective polarizing film 12. Subsequently, only the inside of the second chamber 34 was opened to atmosphere. After that, compressed air was caused to flow into the second chamber 34 to increase the pressure inside the second chamber 34 up to 0.3 MPa, and the reflective polarizing film 12 was pressurized to be pressed against the substrate 11-8 for 10 seconds. After that, as illustrated in FIG. 8F, after the heating and the pressurizing of the reflective polarizing film 12 were stopped so that the second chamber 34 was restored to the atmospheric pressure, the first chamber 33 was also opened to atmosphere.

Next, as illustrated in FIG. 8G, the reflective polarizing film 12 and the substrate 11-8 having the reflective polarizing film 12 bonded thereto were taken out from the first chamber 33 and the second chamber 34. Subsequently, the unrequired reflective polarizing film 12 was cut together with the pressure-sensitive adhesive layer 13 by putting a blade on the reflective polarizing film 12 along the outer edge of the curved surface portion 11a-8 so as to leave only the reflective polarizing film 12 on the curved surface portion 11a-8 of the substrate 11-8. In this manner, a reflective polarizing optical element 10a having a circular shape in plan view was obtained.

For the reflective polarizing optical element 10a manufactured as described above, similarly to Example 1, a region distant by 7 mm from the outer circumference of the curved surface portion 11a-8 of the substrate 11-8 was observed. As a result, separation of 200 μm or more in width was observed at a plurality of positions in the curved surface portion 11a-8 of the substrate 11-8. The separation occurred only in the vicinity of both ends of the curved surface portion 11a-8 in the direction of the reflection axis 12a of the reflective polarizing film 12. Thus, in Example 8, as illustrated in FIG. 8H, in the above-mentioned reflective polarizing optical element 10a, both end portions of the curved surface portion 11a-8 in a direction parallel to the reflection axis 12a were each cut off by 7 mm. As described above, in Example 8, the reflective polarizing optical element 10-8 was manufactured by cutting off a part in which separation has occurred after the reflective polarizing film 12 was bonded to the curved surface portion 11a-8 of the substrate 11-8.

Even for the reflective polarizing optical element 10-8 of Example 8, evaluation similar to that for the reflective polarizing optical element 10 of Example 1 was performed. As a result, in the curved surface portion of the substrate, no separation of 200 μm or more in width was observed. Further, observation was also performed after the temperature cycling test, and it was confirmed that no peeling had progressed to the region distant by 2 mm or more from the outer circumference of the curved surface portion of the substrate. Accordingly, the reflective polarizing optical element 10-8 of Example 8 was evaluated as being satisfactory regarding the separation and the like as shown in Tables 1-1 and 1-2.

### Comparative Example 1

As Comparative Example 1, a case in which a substrate that was a convex lens in which the short diameter and the long diameter were the same, specifically, 50 mm and the half aperture angle θ was 20° was used is described. Specifically, the substrate 11-8 having the shape illustrated in FIG. 8A as described in Example 8 was used. The substrate 11-8 is, as described above, a convex lens having, in plan view, a circular shape in which the length L1 of the short diameter 11c of the curved surface portion 11a-8 is 50 mm, the length L2 of the long diameter 11d is 50 mm, and the half aperture angle θ is 20°. Further, the curved surface portion 11a-8 had a shape not provided with the peripheral edge portion. Further, regarding the manufacturing method, also in Comparative Example 1, the reflective polarizing optical element 10 was manufactured by a method similar to that in Example 1 except that the shape of the substrate was changed and the direction of the reflection axis 12a was not particularly designated at the time of arranging the reflective polarizing film 12.

Even for the reflective polarizing optical element of Comparative Example 1, evaluation similar to that for the reflective polarizing optical element 10-5 of Example 1 was performed. As a result, separation of 300 μm in width was observed at both ends in the reflection axis direction of the curved surface portion 11a-8 of the substrate 11-8. Further, observation was also performed after the temperature cycling test, and it was confirmed that peeling had progressed to the region distant by 2 mm or more from the outer circumference of the curved surface portion 11a-8 of the substrate 11-8. Accordingly, the reflective polarizing optical element 10 of Comparative Example 1 was evaluated as being defective regarding the separation and the like as shown in Tables 1-1 and 1-2.

TABLE 1-1

| | | | | Short | Long | |
|---|---|---|---|---|---|---|
| | | Curved | Half | diameter | diameter | |
| | Substrate | surface | aperture | length | length | |
| | shape | shape | angle θ | L1 (mm) | L2 (mm) | L1/L2 |
| Example 1 | FIG. 4A | convex | 20° C. | 36 | 50 | 0.72 |
| Example 2 | FIG. 4A | convex | 5° C. | 46 | 50 | 0.92 |
| Example 3 | FIG. 4A | convex | 30° C. | 40 | 50 | 0.8 |
| Example 4 | FIG. 5A | convex | 20° C. | 25 | 50 | 0.5 |
| Example 5 | FIG. 4A | concave | 20° C. | 36 | 50 | 0.8 |
| Example 6 | FIG. 4A | convex | 20° C. | 36 | 50 | 0.72 |
| Example 7 | FIG. 5A | convex | 20° C. | 36 | 50 | 0.72 |
| Example 8 | FIG. 8A | convex | 20° C. | 36 | 50 | 0.72 |
| | (cut-off) | | | | | |
| Comparative | FIG. 8A | convex | 20° C. | 50 | 50 | 1 |
| Example 1 | | | | | | |

TABLE 1-2

| | Angle formed | | | |
|---|---|---|---|---|
| | between short | | | Temperature |
| | diameter and | (L1/cosφ)/ | Result | cycling result |
| | slow axis Φ | L2 | (separation) | (peeling) |
| Example 1 | 0° C. | 0.72 | ◯ | ◯ |
| Example 2 | 0° C. | 0.92 | ◯ | ◯ |
| Example 3 | 0° C. | 0.8 | ◯ | ◯ |
| Example 4 | 30° C. | 0.58 | ◯ | ◯ |
| Example 5 | 0° C. | 0.8 | ◯ | ◯ |
| Example 6 | 0° C. | 0.72 | ⊚ | ◯ |
| Example 7 | 0° C. | 0.72 | ⊚ | ◯ |
| Example 8 | 0° C. | 0.72 | ◯ | ◯ |
| Comparative | 0° C. | 1 | X | X |
| Example 1 | | | | |

### Second Embodiment

The reflective polarizing optical element according to the first embodiment described above can be applied to various devices and apparatus such as an optical device, a display apparatus, and an imaging apparatus. In this embodiment, an optical device and a display apparatus are described as specific application examples of the reflective polarizing optical element according to the first embodiment.

### (Optical Device)

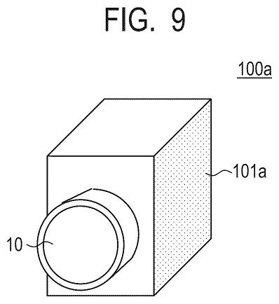

Specific application examples of the reflective polarizing optical element according to the first embodiment include a lens for forming an optical device (photographing optical system) for a camera or a video camera, and a lens for forming an optical device (projecting optical system) for a liquid crystal projector. FIG. 9 is a schematic view for illustrating an example of an exemplary embodiment of the optical device using the reflective polarizing optical element according to the first embodiment. An optical system included in an optical device 100a includes a plurality of lenses arranged in a casing 101a, and the reflective polarizing optical element 10 according to the first embodiment can be used for at least one of those lenses.

### (Display Apparatus)

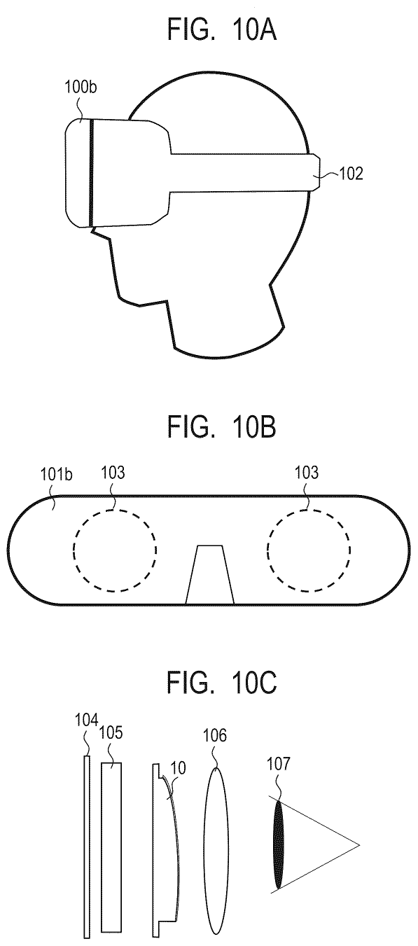

FIG. 10A to FIG. 10C are schematic views for illustrating a configuration of a head mounted display (HMD) 100b which is an example of an exemplary embodiment of a display apparatus using the reflective polarizing optical element according to the first embodiment. FIG. 10A is a side view for illustrating the HMD 100b. FIG. 10B is a front view for illustrating the HMD 100b. FIG. 10C is a schematic view for illustrating an optical system of the HMD 100b.

As illustrated in FIG. 10A and FIG. 10B, the HMD 100b includes a casing 101b, a mounting member 102, and display units 103 for a left eye and a right eye. Each of the display units 103 is provided in the casing 101b. The HMD 100b is mounted on a head of the user by the mounting member 102 so that the display units 103 for the left eye and the right eye are positioned so as to correspond to the left eye and the right eye of the user, respectively.

As illustrated in FIG. 10C, each of the display units 103 includes a display panel 104 and optical systems 10, 105, and 106. For example, the reflective polarizing optical element according to the first embodiment can be used for the optical system. The display panel 104 is a display portion formed of an organic electroluminescence (EL) panel, a liquid crystal panel, or the like, and displays a corresponding video for the left eye or the right eye. The optical systems 10, 105, and 106 image video light emitted from the display panel 104 to the position of the eye of the user. The optical systems 10, 105, and 106 may include optical-path changing elements depending on the design of the HMD 100b. Examples of the optical-path changing elements include transmissive optical elements such as a convex lens and a concave lens, reflective optical elements such as a concave mirror, and phase difference optical elements such as a mirror and a half mirror. The reflective polarizing optical element 10 is installed so as to be positioned between the optical system 105 and the optical system 106 and eye. The reflective polarizing optical element 10 forms an optical system together with the optical systems 105 and 106 so as to guide video light that is light emitted from the display panel 104, to the eye of the user, and functions as at least one of optical elements, that is, lenses in the optical system.

Here, a mode using the HMD has been described as the display apparatus to which the reflective polarizing optical element is applied, but the mode of the display apparatus according to this embodiment is not limited to this example. For example, also for a display apparatus in a mode of a projector or the like, the reflective polarizing optical element 10 according to this embodiment can be used similarly to the above-mentioned example.

As described above, a reflective polarizing optical element (10, 10-5, 10-6, 10-8) according to the present disclosure includes a substrate (11, 11-2 to 11-8), and a reflective polarizing film 12 bonded to the substrate. The substrate includes a curved surface portion (11a, 11a-2 to 11a-5, 11a-8) having a surface forming a curved surface, the curved surface portion (11a, 11a-2 to 11a-5, 11a-8) having, in plan view in which the substrate is viewed in an optical axis direction, a first diameter (short diameter 11c) and a second diameter (long diameter 11d) in the plan view which is longer than the first diameter. The reflective polarizing film 12 has a transmission axis 12b and a reflection axis 12a, and is bonded to the curved surface of the curved surface portion. The reflective polarizing film 12 is arranged so that, in the plan view described above, an extension direction of the reflection axis 12a and an extension direction of the first diameter (short diameter 11c) are parallel to each other. Further, the extension direction of the reflection axis 12a and the extension direction of the first diameter can also be arranged so that an angle formed therebetween becomes 30° or less. Regarding this condition, for example, in the case of the substrate 11 exemplified in FIG. 1, the short diameter 11c can be regarded as a diameter extending in a direction perpendicular to the extension direction of the longest diameter (long diameter 11d) of the curved surface portion 11a in plan view.

In this manner, in the extension direction of the reflection axis 12a which is a direction in which the film is relatively less liable to be extended, the length of the reflective polarizing film 12 to be extended and bonded can be suppressed short. Thus, the load to be applied to the reflective polarizing film 12 due to the extension is relatively reduced, and the occurrence of the separation and the starting point of peeling can be reduced. In order to reduce the occurrence of the separation and the like more effectively, it is preferred to set the extension direction of the first diameter and the extension direction of the reflection axis 12a to match each other. However, when the angle formed between those directions is 30° or less, an extension amount of the reflective polarizing film 12 is an extension amount by which reduction in load to some extent can be expected, and hence the effect of reducing the occurrence of the separation and the like can be expected. When the formed angle is larger than 30°, the difference from the direction of the second diameter is reduced, and hence it becomes difficult to expect superiority of load reduction depending on the bonding direction with respect to the reflective polarizing film 12.

The curved surface portion (11a, 11a-2, 11a-3, 11a-5) in the substrate (11, 11-2, 11-3, 11-5) can have a shape surrounded by an arc and a line in plan view. In this case, the arc can be a plurality of arcs forming parts of the same circle in plan view, and the line can be a line connecting ends of adjacent arcs among the plurality of arcs. In such a case, the first diameter corresponds to the shortest diameter among diameters passing through a center point O of the circle in plan view. Further, the second diameter corresponds to a diameter passing through the center point O and extending in a direction perpendicular in plan view to the extension direction of the first diameter.

Here, the curved surface portion can be formed to have an outer shape including a plurality of arcs having different curvatures, as in the curved surface portion 11a-4 exemplified in FIG. 2C. In this case, the first diameter (short diameter 11c) can be the shortest diameter among diameters passing through a center-of-figure point C of the outer shape in plan view. Further, when the half aperture angle of the curved surface is represented by θ, it is preferred that θ satisfy 0°<θ≤30°. In a design in which the substrate is a lens, the substrate can exhibit the function as the lens when this condition is satisfied.

Here, an angle formed between the first diameter (short diameter 11c) and the reflection axis 12a is represented by φ, a length of the first diameter is represented by L1, and a length of the second diameter is represented by L2. At this time, it is preferred that, in the condition of 5°≤θ≤30°, L1 and L2 satisfy 0.2≤(L1/cos φ)/L2≤−0.0128×θ+0.982. In order to reduce the possibility of occurrence of separation and the like of the reflective polarizing film 12, it is preferred that the ratio of the length L1 of the short diameter 11c to the length L2 of the long diameter 11d be reduced, but reduction in this ratio is restricted in terms of the structure of the lens. With the half aperture angle θ falling within this range, the restriction on L1 in terms of design of the reflective polarizing optical element can be widened.

As exemplified in FIG. 1, the substrate 11 can include a step portion 11e extending in the optical axis direction continuously from an outer circumference of the curved surface portion 11a. Further, the reflective polarizing film 12 may be bonded to reach a part of the step portion 11e from the outer circumference of the curved surface portion 11a. In this case, the reflective polarizing film 12 may be bonded to a part or the whole of a connection part of the step portion 11e over the entire range of the outer circumference of the curved surface portion 11a. In this case, as long as the reflective polarizing film 12 is bonded in a part of the outer circumference, for example, in a range larger than a range of ±15° about a portion in which the short diameter reaches the outer circumference, the effect of reducing the possibility of occurrence of separation and the like can be expected due to the bonding to the step portion 11e. Further, the substrate 11 can include a peripheral edge portion 11b provided at a peripheral edge of the curved surface portion 11a. The peripheral edge portion can be used to, for example, fix the reflective polarizing optical element 10. Further, the reflective polarizing film 12 can be bonded to the curved surface through intermediation of a pressure-sensitive adhesive layer 13.

Further, the present disclosure can provide an optical device. For example, an optical device 100a exemplified in FIG. 9 includes a casing 101a, and an optical system including at least one optical element arranged in the casing. In this case, the optical element can include the above-mentioned reflective polarizing optical element 10. Further, the present disclosure can provide a display apparatus. For example, a display apparatus (HMD 100b) exemplified in FIG. 10A to FIG. 10C can include a casing 101b, an optical system (10, 105, 106), and a display portion (display panel 104). An optical system including at least one optical element (10) arranged in the casing 101b can be used as the optical system. The display portion emits light to be guided by the optical system.

Further, the present disclosure can provide a method of manufacturing a reflective polarizing optical element. In this manufacturing method, a substrate (11, 11-2, 11-3, 11-5) is used. The substrate (11, 11-2, 11-3, 11-5) has, in plan view as viewed in an optical axis direction, a first diameter (short diameter 11c) and a second diameter (long diameter 11d) in the plan view which is longer than the first diameter (11c). As described above, the reflective polarizing film 12 is bonded to a curved surface portion (11a, 11a-2, 11a-3, 11a-5) having a surface forming a curved surface in this substrate. Further, at this time, the reflective polarizing film 12 having a transmission axis 12b and a reflection axis 12a is arranged so that, in plan view, an extension direction of the reflection axis 12a and an extension direction of the first diameter are parallel to each other. Further, the reflective polarizing film 12 can also be bonded so that an angle formed between the extension direction of the reflection axis 12a and the extension direction of the first diameter becomes 30° or less.

The reflective polarizing film 12 is bonded to the curved surface portion (11a, 11a-2, 11a-3, 11a-5) by being pressed against the substrate (11, 11-2, 11-3, 11-5). Further, in the exemplified manufacturing method, at the time of bonding the reflective polarizing film 12, the substrate 11 can be arranged so that a tangent line at a center point of the first diameter (short diameter 11c) of the curved surface portion 11a becomes parallel to the reflective polarizing film 12. Further, the reflective polarizing film 12 can be bonded to the curved surface portion 11a-5 in a heated state (FIG. 4D and others). In addition, the substrate 11 can include a step portion 11e extending in the optical axis direction continuously from the outer circumference of the curved surface portion 11a, and the reflective polarizing film 12 can be bonded to reach a part of the step portion 11e-5 from the outer circumference of the curved surface portion 11a-5.

Further, the present disclosure can provide a method of manufacturing a reflective polarizing optical element illustrated in, for example, FIG. 8A to FIG. 8H. This manufacturing method can include a step of bonding the reflective polarizing film 12 to the substrate 11-8, and a step of cutting a curved surface portion of the curved surface portion 11a-8 of the substrate 11-8 together with the bonded reflective polarizing film 12. In this manufacturing method, at the time of cutting, at least one end portion including the curved surface portion 11a-8 of the substrate 11-8 in a direction included in a range in which the angle formed with the reflection axis 12a in plan view as viewed in the optical axis direction becomes 30° or less is cut off.

With the above-mentioned manufacturing method, for example, the reflective polarizing optical element exemplified in the first embodiment can be obtained. In the reflective polarizing optical element, the occurrence of separation of the film in the peripheral portion can be reduced.

According to an aspect of the present disclosure, the reflective polarizing optical element with which the occurrence of separation of the film in the peripheral portion is reduced can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-101321, filed Jun. 24, 2024, which is hereby incorporated by reference herein in its entirety.

What is claimed is:

1. A reflective polarizing optical element comprising:
a substrate including a curved surface portion having a surface forming a curved surface, the curved surface portion having, in plan view as viewed in an optical axis direction, a first diameter and a second diameter in the plan view which is longer than the first diameter; and
a reflective polarizing film having a transmission axis and a reflection axis, the reflective polarizing film being bonded to the curved surface of the curved surface portion, the reflective polarizing film being arranged so that, in the plan view, an angle formed between an extension direction of the reflection axis and an extension direction of the first diameter becomes 30° or less.

2. The reflective polarizing optical element according to claim 1, wherein the extension direction of the reflection axis and the extension direction of the first diameter are arranged in parallel to each other.

3. The reflective polarizing optical element according to claim 2,
wherein the curved surface portion has, in the plan view, a shape surrounded by a plurality of arcs and a line, the plurality of arcs forming parts of the same circle in the plan view, the line connecting ends of adjacent arcs among the plurality of arcs, and
wherein the first diameter is a shortest diameter among diameters passing through a center point of the circle in the plan view.

4. The reflective polarizing optical element according to claim 1, wherein the first diameter is a shortest diameter of the substrate in the plan view.

5. The reflective polarizing optical element according to claim 4,
wherein the curved surface portion has an outer shape including a plurality of arcs having different curvatures, and
wherein the first diameter is a shortest diameter among diameters passing through a center-of-figure point of the outer shape in the plan view.

6. The reflective polarizing optical element according to claim 5, wherein the second diameter is a longest diameter among the diameters passing through the center-of-figure point of the outer shape in the plan view.

7. The reflective polarizing optical element according to claim 1,
wherein the curved surface portion has, in the plan view, a shape surrounded by a plurality of arcs and a line, the plurality of arcs forming parts of the same circle in the plan view, the line connecting ends of adjacent arcs among the plurality of arcs, and
wherein the first diameter is a shortest diameter among diameters passing through a center point of the circle in the plan view.

8. The reflective polarizing optical element according to claim 7, wherein the second diameter is a diameter passing through the center point and extending in a direction perpendicular in the plan view to the extension direction of the first diameter.

9. The reflective polarizing optical element according to claim 7, wherein θ satisfies:
0°<θ≤30°,
where θ represents a half aperture angle of the curved surface.

10. The reflective polarizing optical element according to claim 9, wherein, in a condition of 5°≤θ≤30°, L1 and L2 satisfy:
0.2≤(L1/cos φ)/L2≤−0.0128×θ+0.982,
where φ represents an angle formed between the first diameter and the reflection axis, L1 represents a length of the first diameter, and L2 represents a length of the second diameter.

11. The reflective polarizing optical element according to claim 1,
wherein the substrate includes a step portion extending continuously from an outer circumference of the curved surface portion, and
wherein the reflective polarizing film is bonded to reach a part of the step portion from the outer circumference of the curved surface portion.

12. The reflective polarizing optical element according to claim 1, wherein the substrate includes a peripheral edge portion provided at a peripheral edge of the curved surface portion.

13. The reflective polarizing optical element according to claim 1, wherein the reflective polarizing film is bonded to the curved surface through intermediation of a pressure-sensitive adhesive layer.

14. An optical device comprising:
a casing; and
an optical system including at least one optical element arranged in the casing,
wherein the at least one optical element includes the reflective polarizing optical element of claim 1.

15. A display apparatus comprising:
a casing;
an optical system including at least one optical element arranged in the casing; and
a display portion configured to emit light to be guided by the optical system,
wherein the at least one optical element includes the reflective polarizing optical element of claim 1.

16. A method of manufacturing a reflective polarizing optical element, the method comprising bonding a reflective polarizing film to a curved surface portion in a substrate, the curved surface having a first diameter in plan view as viewed in an optical axis direction and a second diameter in the plan view which is longer than the first diameter, the curved surface portion having a surface forming a curved surface, the reflective polarizing film having a transmission axis and a reflection axis,
wherein the bonding includes bonding the reflective polarizing film so that, in the plan view, an angle formed between an extension direction of the reflection axis and an extension direction of the first diameter is 30° or less.

17. The method of manufacturing a reflective polarizing optical element according to claim 16, wherein the bonding includes bonding the reflective polarizing film so that, in the plan view, the extension direction of the reflection axis and the extension direction of the first diameter are parallel to each other.

18. The method of manufacturing a reflective polarizing optical element according to claim 16,
wherein the curved surface portion has, in the plan view, a shape surrounded by a plurality of arcs and a line, the plurality of arcs forming parts of the same circle in the plan view, the line connecting ends of adjacent arcs among the plurality of arcs, and
wherein the first diameter is a shortest diameter among diameters passing through a center point of the circle in the plan view.

19. The method of manufacturing a reflective polarizing optical element according to claim 16,
wherein the substrate includes a step portion extending continuously from an outer circumference of the curved surface portion, and
wherein the reflective polarizing film is bonded to reach a part of the step portion from the outer circumference of the curved surface portion.

20. A method of manufacturing a reflective polarizing optical element, the method comprising:
bonding a reflective polarizing film having a transmission axis and a reflection axis to a curved surface portion of a substrate including the curved surface portion having a surface forming a curved surface; and
cutting off at least one end portion including the curved surface portion of the substrate in a direction included in a range in which, in plan view as viewed in an optical axis direction, an angle formed with the reflection axis becomes 30° or less.
